(19) United States
(12) Patent Application Publication
(10) Pub. No.: US 2017/0153519 A1
(43) Pub. Date: Jun. 1, 2017

(54) MANUFACTURE METHOD OF COLOR FILTER ON ARRAY LIQUID CRYSTAL DISPLAY PANEL AND STRUCTURE THEREOF

(71) Applicant: Shenzhen China Star Optoelectronics Technology Co. Ltd., Shenzhen City (CN)

(72) Inventor: Yong Xu, Shenzhen City (CN)

(21) Appl. No.: 14/781,588

(22) PCT Filed: Aug. 21, 2015
(86) PCT No.: PCT/CN2015/087725

§ 371 Date: Oct. 1, 2015

(30) Foreign Application Priority Data
Jul. 15, 2015 (CN) 201510417412.X

(51) Int. Cl. G02F 1/1362; G02F 1/1368; G02F 1/1339; G02F 1/1341; G02F 1/1335; G02F 1/1343

(52) U.S. Cl. CPC G02F 1/136227; G02F 1/133516; G02F 1/136209; G02F 1/13439; G02F 1/1339; G02F 1/1341; G02F 1/1368; G02F 2001/13398

(57) ABSTRACT

The present invention provides a manufacture method of a Color Filter On Array liquid crystal display panel and a structure thereof. The method comprises: manufacturing a color resist layer (30) on a first protective layer (25), and removing the color resist layer (30) in an area above the gate (21) and the source/the drain (24), and deposing a second protective layer (40) covering the color resist layer (30) and the first protective layer (25); the pixel electrode (50) is formed on the second protective layer (40), and contacts with the source/the drain (24) through a via hole (45) penetrating the second protective layer (40) and the first protective layer (25); and then, filling black matrix material in the area of which the color resist layer (30) is removed, and employing a slit diffraction mask to manufacture a black matrix (60) and spacers (70) on the black matrix (60).

### FIELD OF THE INVENTION

The present invention relates to a liquid crystal display technology field, and more particularly to a manufacture method of a Color Filter On Array liquid crystal display panel and a structure thereof.

### BACKGROUND OF THE INVENTION

With the development of display technology, the flat panel device, such as Liquid Crystal Display (LCD) possesses advantages of high image quality, power saving, thin body and wide application scope. Thus, it has been widely applied in various consumer electrical products, such as mobile phone, television, personal digital assistant, digital camera, notebook, laptop, and becomes the major display device.

Most of the liquid crystal displays on the present market are backlight type liquid crystal displays, which comprise a liquid crystal display panel and a backlight module. Generally, the liquid crystal display panel comprises a Color Filter (CF), a Thin Film Transistor Array Substrate (TFT Array Substrate) and a Liquid Crystal Layer positioned between the two substrates. The working principle is that the light of backlight module is reflected to generate images by applying driving voltages to the two substrate for controlling the rotations of the liquid crystal molecules. At the side of the Color Filter, the color resists of various colors for filtering the light and the black matrix for shielding the light are located. Because the misalignment can easily happen as oppositely assembling the Color Filter and the Array Substrate, it results in problems of aperture ratio decrease and light leakage of the liquid crystal display panel. For solving the aforesaid problems, a Color Filter On Array liquid crystal display panel is proposed. The Color Filter can be manufactured at one side of the TFT Array Substrate (Color Filter On Array, COA), and the black matrix is manufactured at one side of the Array Substrate (Black Matrix On Array, BOA), and the photospacers are manufactured at one side of the Array Substrate (Photo Spacer On Array).The Color Filter On Array liquid crystal display panel integrates both the Color Filter and the black matrix at one side of the Array Substrate, which can reduce the misalignment, and increase the aperture ratio, and reduce the parasitic capacitance, and be applicable for forming curved appearance.

However, the color resist layer is required to open via holes in the manufacture process of the Color Filter On Array liquid crystal display panel according to prior art to electrically connect the pixel electrode to the source/the drain of the TFT. The resulted problem is that opening the via hole in the color resist layer can cause the decrease of the aperture ratio, and the opened via hole can hide air with high possibility. When the liquid crystal display panel suffers high temperature, vibration or shock, the hidden air may runout to form Bubbles and occupy the positions of the liquid crystals to result in abnormal display.

### SUMMARY OF THE INVENTION

An objective of the present invention is to provide a manufacture method of a Color Filter On Array liquid crystal display panel, of which the connection between the pixel electrode and the source/the drain can be realized under the premise of without opening the hole in the color resist layer to raise the aperture ratio and prevent the bubble occurrence. The display quality of the liquid crystal display panel can be promoted, and meanwhile, the mask can be saved to reduce the production cost.

Another objective of the present invention is to provide a structure of a Color Filter On Array liquid crystal display panel, of which the aperture ratio is higher, and the display quality is better and the production cost is lower.

For realizing the aforesaid objective, the present invention provides a manufacture method of a Color Filter On Array liquid crystal display panel, comprising steps of:

step 1, providing a first substrate, and sequentially manufacturing a gate, a gate isolation layer, a semiconductor layer and a source/a drain on the first substrate, and forming a first protective layer covering the source/the drain, the semiconductor layer and the first substrate by deposition processes;

step 2, manufacturing a color resist layer on the first protective layer, and removing the color resist layer in an area above the gate and the source/the drain by a wet etching process;

step 3, forming a second protective layer covering the color resist layer and the first protective layer by a deposition process, and etching a via hole penetrating the second protective layer and the first protective layer to expose a partial surface of the source/the drain;

step 4, forming a pixel electrode on the second protective layer, and the pixel electrode contacts with the source/the drain through the via hole;

step 5, filling black matrix material in the area of which the color resist layer is removed in the step 2, and employing a slit diffraction mask to manufacture a black matrix shielding the gate and the source/the drain and spacers on the black matrix to be in one with the black matrix at the same time;

step 6, providing a second substrate, and manufacturing a common electrode on the second substrate, and oppositely assembling the first substrate and the second substrate, and injecting liquid crystals between the first substrate and the second substrate to package the first substrate and the second substrate.

In the step 2, the color resist layer comprises: red color resist, green color resist and blue color resist.

In the step 4, material of the pixel electrode is ITO.

In the step 5, the black matrix material is acrylic black photoresist.

In the step 5, a thickness of filling the black matrix material is larger than a thickness of the color resist layer.

The present invention further provides a structure of a Color Filter On Array liquid crystal display panel, comprising: a first substrate, a gate located on the first substrate, a gate isolation layer covering the gate, a semiconductor layer located on the gate isolation layer, a first protective layer contacting with a source/a drain at two sides of the semiconductor layer, respectively and covering the source/the drain, the semiconductor layer and the first substrate, a color resist layer located on the first protective layer, and disconnected in an area above the gate and the source/the drain, a second protective layer covering the color resist layer and the first protective layer, a pixel electrode located on the second protective layer and contacting a partial surface of the source/the drain through a via hole penetrating the second protective layer and the first protective layer, a black matrix filling in the area of which the color resist layer is disconnected and shielding the gate and the source/the drain and spacers on the black matrix to be in one with the black matrix;

the black matrix and the photospacers are formed at the same time in the manufacture process.

The structure of the Color Filter On Array liquid crystal display panel further comprises a second substrate oppositely located to the first substrate, a common electrode located at one side of the second substrate facing the first substrate and liquid crystals sandwiched between the first substrate and the second substrate.

The color resist layer comprises red color resist, green color resist and blue color resist.

Material of the pixel electrode is ITO.

Material of the black matrix and the spacers is Acrylic black photoresist.

The present invention further provides a structure of a Color Filter On Array liquid crystal display panel, comprising: a first substrate, a gate located on the first substrate, a gate isolation layer covering the gate, a semiconductor layer located on the gate isolation layer, a first protective layer contacting with a source/a drain at two sides of the semiconductor layer, respectively and covering the source/the drain, the semiconductor layer and the first substrate, a color resist layer located on the first protective layer, and disconnected in an area above the gate and the source/the drain, a second protective layer covering the color resist layer and the first protective layer, a pixel electrode located on the second protective layer and contacting a partial surface of the source/the drain through a via hole penetrating the second protective layer and the first protective layer, a black matrix filling in the area of which the color resist layer is disconnected and shielding the gate and the source/the drain and spacers on the black matrix to be in one with the black matrix;

the black matrix and the photospacers are formed at the same time in the manufacture process;

wherein the color resist layer comprises red color resist, green color resist and blue color resist;

wherein material of the pixel electrode is ITO;

wherein material of the black matrix and the spacers is Acrylic black photoresist.

The benefits of the present invention are: the present invention provides a manufacture method of a Color Filter On Array liquid crystal display panel, which comprises sequentially manufacturing a gate, a gate isolation layer, a semiconductor layer, a source/a drain and a first protective layer on the first substrate, and manufacturing a color resist layer, and removing the color resist layer in an area above the gate and the source/the drain by a wet etching process, and deposing a second protective layer covering the color resist layer and the first protective layer; the pixel electrode is formed on the second protective layer, and the pixel electrode contacts with the source/the drain through a via hole penetrating the second protective layer and the first protective layer. The connection between the pixel electrode and the source/the drain can be realized without opening the hole in the color resist layer to raise the aperture ratio and prevent the bubble occurrence for promoting the display quality of the liquid crystal display panel; and then, filling black matrix material in the area of which the color resist layer is removed by the wet etching process, and employing a slit diffraction mask to manufacture a black matrix shielding the gate and the source/the drain and spacers on the black matrix to be in one with the black matrix at the same time to save the mask, and to simplify the manufacture process, and to reduce the production cost. The present invention provides a structure of a Color Filter On Array liquid crystal display panel. The color resist layer is located on the first protective layer and disconnected above the gate and the source/the drain. The second protective layer covers the color resist layer and the first protective layer. The pixel electrode is located on the second protective layer, and contacts with a partial surface of the source/the drain through a via hole penetrating the second protective layer and the first protective layer with no need of opening the via hole in the color resist layer. The black matrix fills in the disconnected area of the color resist layer, and the spacers on the black matrix is in one with the black matrix. The two are formed at the same time in the manufacture process to make the aperture ratio of the Color Filter On Array liquid crystal display panel higher, and the display quality better, and the production cost lower.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a flowchart of a manufacture method of a Color Filter On Array liquid crystal display panel according to the present invention;

FIG. 2 is a diagram of step 1 in the manufacture method of the Color Filter On Array liquid crystal display panel according to the present invention;

FIG. 3 is a diagram of step 2 in the manufacture method of the Color Filter On Array liquid crystal display panel according to the present invention;

FIG. 4 is a diagram of step 3 in the manufacture method of the Color Filter On Array liquid crystal display panel according to the present invention;

FIG. 5 is a diagram of step 4 in the manufacture method of the Color Filter On Array liquid crystal display panel according to the present invention;

FIG. 6 is a diagram of step 5 in the manufacture method of the Color Filter On Array liquid crystal display panel according to the present invention;

FIG. 7 is a diagram of step 6 in the manufacture method of the Color Filter On Array liquid crystal display panel according to the present invention and a diagram of a structure of the Color Filter On Array liquid crystal display panel according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

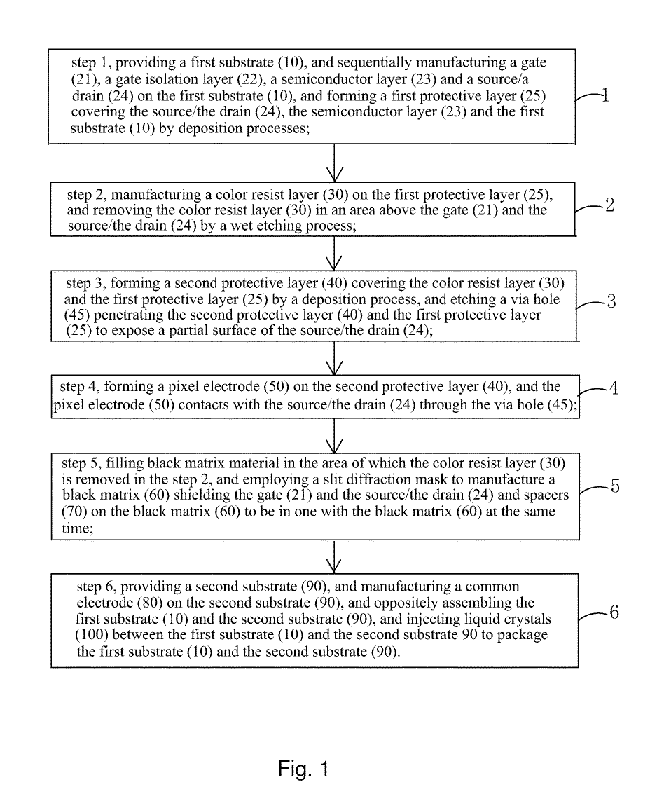

Please refer to FIG. 1. The present invention first provides a manufacture method of a Color Filter On Array liquid crystal display panel, comprising steps of:

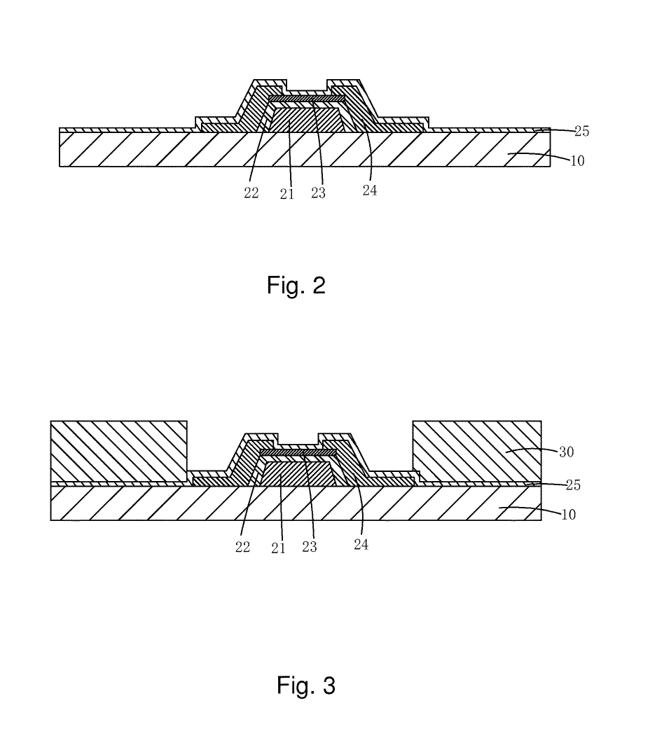

step 1, referring to FIG. 2, providing a first substrate 10, and sequentially manufacturing a gate 21, a gate isolation layer 22, a semiconductor layer 23 and a source/a drain 24 on the first substrate 10, and forming a first protective layer 25 covering the source/the drain 24, the semiconductor layer 23 and the first substrate 10 by deposition processes.

Specifically, the first substrate 10 is preferably to be a glass substrate; the gate 21 is obtained by deposing a first metal layer and implementing pattern process to the first metal layer, and material of the first metal layer can be one or more of copper (Cu), aluminum (Al), molybdenum (Mo), titanium (Ti); the gate isolation layer 22 is obtained by chemical vapor deposition, and material can be selected from Silicon Oxide (SiOx), Silicon Nitride (SiNx), or a combination of the two; the semiconductor layer 23 is amorphous silicon or polysilicon; the source/the drain 24 is obtained by deposing a second metal layer and implementing pattern process to the second metal layer, and material of the second metal layer can be one or more of Cu, Al, Mo, Ti; material of the first protective layer 25 can be selected from SiOx, SiNx, or a combination of the two.

step 2, referring to FIG. 3, manufacturing a color resist layer 30 on the first protective layer 25, and removing the color resist layer 30 in an area above the gate 21 and the source/the drain 24 by a wet etching process.

Specifically, the color resist layer 30 comprises: red color resist, green color resist and blue color resist. Besides, the color resist layer 30 can be added with color resist of other colors, such as white color resist, yellow color resist on actual demands.

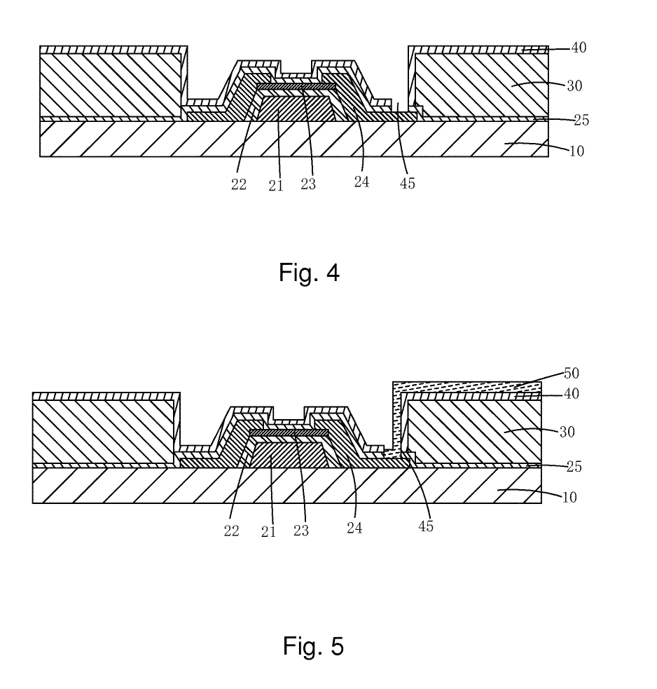

step 3, referring to FIG. 4, forming a second protective layer 40 covering the color resist layer 30 and the first protective layer 25 by a deposition process, and etching a via hole 45 penetrating the second protective layer 40 and the first protective layer 25 to expose a partial surface of the source/the drain 24.

Specifically, material of the second protective layer 40 can be selected from SiOx, SiNx, or a combination of the two; the dry etching process is employed to etch the via hole 45 penetrating the second protective layer 40 and the first protective layer 25.

step 4, referring to FIG. 5, forming a pixel electrode 50 on the second protective layer 40, and the pixel electrode 50 contacts with the source/the drain 24 through the via hole 45.

Specifically, material of the pixel electrode 50 is ITO; the pixel electrode 50 is formed by evaporating an ITO thin film and etching the ITO thin film.

The connection between the pixel electrode 50 and the source/the drain 24 can be realized without opening the hole in the color resist layer 30 to raise the aperture ratio and prevent the bubble occurrence. The display quality of the liquid crystal display panel can be promoted.

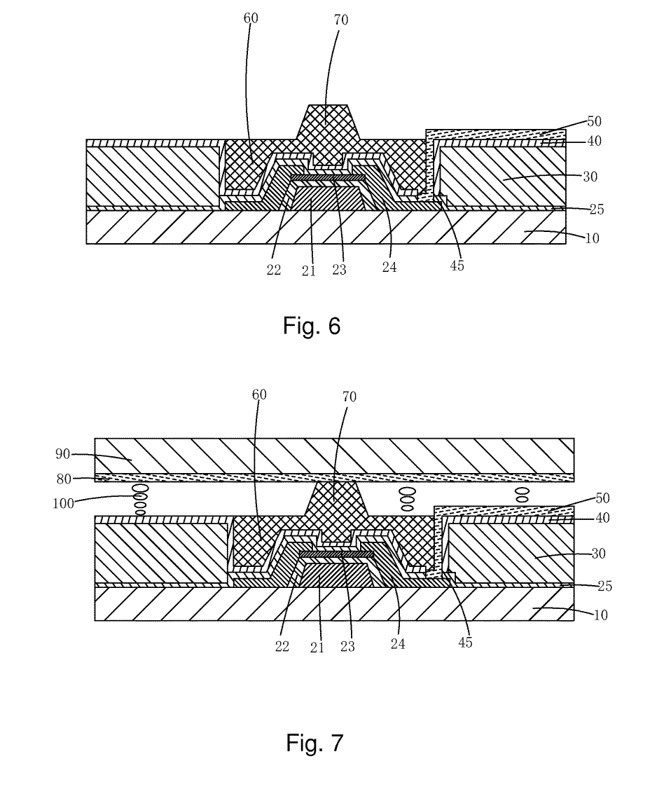

step 5, referring to FIG. 6, filling black matrix material in the area of which the color resist layer 30 is removed in the step 2, and employing a slit diffraction mask to manufacture a black matrix 60 shielding the gate 21 and the source/the drain 24 and spacers 70 on the black matrix 60 to be in one with the black matrix 60 at the same time.

Particularly, in the step 5, a thickness of filling the black matrix material is larger than a thickness of the color resist layer 30 to make the spacers 70 higher than the color resist layer 30; material of the black matrix and the spacers is Acrylic black photoresist. With the slit diffraction mask process, the black matrix 60 and the spacers 70 on the black matrix 60 to be in one with the black matrix 60 can be manufactured in one single process at the same time. In comparison with prior art, of which one regular mask is used to manufacture the black matrix, and another mask is used to manufacture the photospacers. The amount of the masks is reduced to simplify the manufacture process and reduce the production cost.

step 6, referring to FIG. 7, providing a second substrate 90, and manufacturing a common electrode 80 on the second substrate 90, and oppositely assembling the first substrate 10 and the second substrate 90, and injecting liquid crystals 100 between the first substrate 10 and the second substrate 90 to package the first substrate 10 and the second substrate 90.

Specifically, the second substrate 90 is a glass substrate, and material of the common electrode is ITO.

Please refer to FIG. 7. On the basis of the aforesaid manufacture method of the Color Filter On Array liquid crystal display panel, the present invention further provides a structure of a Color Filter On Array liquid crystal display panel, comprising: a first substrate 10, a gate 21 located on the first substrate 10, a gate isolation layer 22 covering the gate 21, a semiconductor layer 23 located on the gate isolation layer 22, a first protective layer 25 contacting with a source/a drain 24 at two sides of the semiconductor layer 23, respectively and covering the source/the drain 24, the semiconductor layer 23 and the first substrate 10, a color resist layer 30 located on the first protective layer 25, and disconnected in an area above the gate 21 and the source/the drain 24, a second protective layer 40 covering the color resist layer 30 and the first protective layer 25, a pixel electrode 50 located on the second protective layer 40 and contacting a partial surface of the source/the drain 24 through a via hole 45 penetrating the second protective layer 40 and the first protective layer 25, a black matrix 60 filling in the area of which the color resist layer 30 is disconnected and shielding the gate 21 and the source/the drain 24, spacers 70 on the black matrix 60 to be in one with the black matrix 60, and a second substrate 90 oppositely located to the first substrate 10, a common electrode 80 at one side of the second substrate 90 facing the first substrate 10 and liquid crystals 100 sandwiched between the first substrate 10 and the second substrate 90. The black matrix 60 and the spacers 70 are formed at the same time in the manufacture process.

Specifically, the color resist layer 30 comprises: red color resist, green color resist and blue color resist. Besides, the color resist layer 30 can be added with color resist of other colors, such as white color resist, yellow color resist on actual demands. Material of the pixel electrode 50 and the common electrode 80 is ITO. Material of the black matrix 60 and the spacers 70 is Acrylic black photoresist. The black matrix 60 and the spacers 70 are formed with a slit diffraction mask at the same time.

Furthermore, both the first substrate 10 and the second substrate 90 are glass substrates; all materials of the gate isolation layer 22, the first protective layer 25 and the second protective layer 40 can be selected from SiOx, SiNx, or a combination of the two. Material of the gate 21 and the source/the drain 24 can be one or more of Cu, Al, Mo, Ti.

In the structure of a Color Filter On Array liquid crystal display panel of the present invention, the color resist layer 30 is located on the first protective layer 25 and disconnected above the gate 21 and the source/the drain 24. The second protective layer 40 covers the color resist layer 30 and the first protective layer 25. The pixel electrode 50 is located on the second protective layer 40, and contacts with a partial surface of the source/the drain 24 through a via hole 45 penetrating the second protective layer 40 and the first protective layer 25 with no need of opening the via hole in the color resist layer 30. The black matrix 60 fills in the disconnected area of the color resist layer 30, and the spacers 70 on the black matrix 60 is in one with the black matrix 60. The two are formed at the same time in the manufacture process to make the aperture ratio of the Color Filter On Array liquid crystal display panel higher, and the display quality better, and the production cost lower.

In conclusion, the present invention provides a manufacture method of a Color Filter On Array liquid crystal display panel, which comprises sequentially manufacturing a gate, a gate isolation layer, a semiconductor layer, a source/a drain and a first protective layer on the first substrate, and manufacturing a color resist layer, and removing the color resist layer in an area above the gate and the source/the drain by a wet etching process, and deposing a second protective layer covering the color resist layer and the first protective layer; the pixel electrode is formed on the second protective layer, and the pixel electrode contacts with the source/the drain through a via hole penetrating the second protective layer and the first protective layer. The connection between the pixel electrode and the source/the drain can be realized without opening the hole in the color resist layer to raise the aperture ratio and prevent the bubble occurrence for promoting the display quality of the liquid crystal display panel; and then, filling black matrix material in the area of which the color resist layer is removed by the wet etching process, and employing a slit diffraction mask to manufacture a black matrix shielding the gate and the source/the drain and spacers on the black matrix to be in one with the black matrix at the same time to save the mask, and to simplify the manufacture process, and to reduce the production cost. In the structure of a Color Filter On Array liquid crystal display panel provide by the present invention, the color resist layer is located on the first protective layer and disconnected above the gate and the source/the drain. The second protective layer covers the color resist layer and the first protective layer. The pixel electrode is located on the second protective layer, and contacts with a partial surface of the source/the drain through a via hole penetrating the second protective layer and the first protective layer with no need of opening the via hole in the color resist layer. The black matrix fills in the disconnected area of the color resist layer, and the spacers on the black matrix is in one with the black matrix. The two are formed at the same time in the manufacture process to make the aperture ratio of the Color Filter On Array liquid crystal display panel higher, and the display quality better, and the production cost lower.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A manufacture method of a Color Filter On Array liquid crystal display panel, comprising steps of:
step 1, providing a first substrate, and sequentially manufacturing a gate, a gate isolation layer, a semiconductor layer and a source/a drain on the first substrate, and forming a first protective layer covering the source/the drain, the semiconductor layer and the first substrate by deposition processes;
step 2, manufacturing a color resist layer on the first protective layer, and removing the color resist layer in an area above the gate and the source/the drain by a wet etching process;
step 3, forming a second protective layer covering the color resist layer and the first protective layer by a deposition process, and etching a via hole penetrating the second protective layer and the first protective layer to expose a partial surface of the source/the drain;
step 4, forming a pixel electrode on the second protective layer, and the pixel electrode contacts with the source/the drain through the via hole;
step 5, filling black matrix material in the area of which the color resist layer is removed in the step 2, and employing a slit diffraction mask to manufacture a black matrix shielding the gate and the source/the drain and spacers on the black matrix to be in one with the black matrix at the same time;
step 6, providing a second substrate, and manufacturing a common electrode on the second substrate, and oppositely assembling the first substrate and the second substrate, and injecting liquid crystals between the first substrate and the second substrate to package the first substrate and the second substrate.

2. The manufacture method of the Color Filter On Array liquid crystal display panel according to claim 1, wherein in the step 2, the color resist layer comprises:
red color resist, green color resist and blue color resist.

3. The manufacture method of the Color Filter On Array liquid crystal display panel according to claim 1, wherein in the step 4, material of the pixel electrode is ITO.

4. The manufacture method of the Color Filter On Array liquid crystal display panel according to claim 1, wherein in the step 5, the black matrix material is acrylic black photoresist.

5. The manufacture method of the Color Filter On Array liquid crystal display panel according to claim 1, wherein in the step 5, a thickness of filling the black matrix material is larger than a thickness of the color resist layer.

6. A structure of a Color Filter On Array liquid crystal display panel, comprising: a first substrate, a gate located on the first substrate, a gate isolation layer covering the gate, a semiconductor layer located on the gate isolation layer, a first protective layer contacting with a source/a drain at two sides of the semiconductor layer, respectively and covering the source/the drain, the semiconductor layer and the first substrate, a color resist layer located on the first protective layer, and disconnected in an area above the gate and the source/the drain, a second protective layer covering the color resist layer and the first protective layer, a pixel electrode located on the second protective layer and contacting with a partial surface of the source/the drain through a via hole penetrating the second protective layer and the first protective layer, a black matrix filling in the area of which the color resist layer is disconnected and shielding the gate and the source/the drain and spacers on the black matrix to be in one with the black matrix;
the black matrix and the photospacers are formed at the same time in the manufacture process.

7. The structure of the Color Filter On Array liquid crystal display panel according to claim 6, further comprising a second substrate oppositely located to the first substrate, a common electrode located at one side of the second substrate facing the first substrate and liquid crystals sandwiched between the first substrate and the second substrate.

8. The structure of the Color Filter On Array liquid crystal display panel according to claim 6, wherein the color resist layer comprises: red color resist, green color resist and blue color resist.

9. The structure of the Color Filter On Array liquid crystal display panel according to claim 6, wherein material of the pixel electrode is ITO.

10. The structure of the Color Filter On Array liquid crystal display panel according to claim 6, wherein material of the black matrix and the spacers is acrylic black photoresist.

11. A structure of a Color Filter On Array liquid crystal display panel, comprising:
a first substrate, a gate located on the first substrate, a gate isolation layer covering the gate, a semiconductor layer located on the gate isolation layer, a first protective layer contacting with a source/a drain at two sides of the semiconductor layer, respectively and covering the source/the drain, the semiconductor layer and the first substrate, a color resist layer located on the first protective layer, and disconnected in an area above the gate and the source/the drain, a second protective layer covering the color resist layer and the first protective layer, a pixel electrode located on the second protective layer and contacting with a partial surface of the source/the drain through a via hole penetrating the second protective layer and the first protective layer, a black matrix filling in the area of which the color resist layer is disconnected and shielding the gate and the source/the drain and spacers on the black matrix to be in one with the black matrix;
the black matrix and the photospacers are formed at the same time in the manufacture process;
wherein the color resist layer comprises red color resist, green color resist and blue color resist;
wherein material of the pixel electrode is ITO;
wherein material of the black matrix and the spacers is Acrylic black photoresist.

12. The structure of the Color Filter On Array liquid crystal display panel according to claim 11, further comprising a second substrate oppositely located to the first substrate, a common electrode located at one side of the second substrate facing the first substrate and liquid crystals sandwiched between the first substrate and the second substrate.
